(19) United States
(12) Patent Application Publication
(10) Pub. No.: US 2023/0302762 A1
(43) Pub. Date: Sep. 28, 2023

(54) THERMAL INSULATION HEADLINER FOR AUTOMOBILE AND METHOD OF FABRICATING THE SAME

(71) Applicant: ES GLOBAL Co., Ltd., Gwangju (KR)

(72) Inventors: Jungpil Han, Gwangju (KR); Donggyu Lim, Gwangju (KR)

(21) Appl. No.: 18/115,035

(22) Filed: Feb. 28, 2023

(30) Foreign Application Priority Data
Feb. 28, 2022 (KR) 10-2022-025822

(51) Int. Cl. B32B 5/02; B32B 37/12; B32B 27/40; B32B 5/12; B32B 37/10

(52) U.S. Cl. CPC B32B 5/022; B32B 5/12; B32B 27/40; B32B 37/10; B32B 37/1207; B32B 2037/1215; B32B 2262/101; B32B 2605/08

(57) ABSTRACT

Disclosed are an insulation headliner for automobiles, which maximizes the insulation performance of the headliner constituting an interior ceiling of automobiles requiring improved fuel efficiency, such as electric vehicles or hybrid vehicles, and a method for manufacturing the same, the headliner for automobiles includes a base layer, a hot melt layer laminated on the base layer, and a vacuum insulator layer laminated on the hot melt layer.

### CROSS REFERENCE TO RELATED APPLICATION

This application claims priority of Korean Patent Application No. 10-2022-0025822, filed on Feb. 28, 2022, in the KIPO (Korean Intellectual Property Office), the disclosure of which is incorporated herein entirely by reference.

### BACKGROUND OF THE INVENTION

### Field of the Invention

The present invention relates to an insulation technology for automobiles, and more particularly, an insulation headliner for automobiles which maximizes the insulation performance of the headliner constituting a ceiling interior of automobiles requiring improved fuel efficiency such as electric vehicles or hybrid vehicles, and a manufacturing method thereof.

### DESCRIPTION OF THE RELATED ART

Demand for energy conservation and environmental protection is increasing worldwide, and regulations and systems are being strengthened in this regard. In recent years, as energy standards in each country have been strengthened, the demand for improving the performance of vacuum insulators has also increased. Accordingly, research and development for lowering the initial thermal conductivity of the vacuum insulator to a predetermined level, for example, about 1.5 mW/mk or less and further improving the insulation performance are required. In addition, there is a need to secure a vacuum insulator which may reduce the manufacturing cost of the vacuum insulator and may easily adjust the thickness according to the application, and its manufacturing process.

There is a similar energy saving demand in the automobile sector. Electric vehicles or hybrid vehicles may use battery power as energy required for cooling and heating as well as electric devices including infotainment. In particular, in the case of an electric vehicle, electric energy is entirely used for heating and cooling, and the driving distance decreases as much as the use of electric energy. In particular, in the winter season, when an electric vehicle drives while running a heating device, the driving distance on a single charge may rapidly decrease by more than 30%, and the lower the outside temperature, the lower the driving distance. Similarly, in summer, even when the electric vehicle is driven while the air conditioner is running, the driving distance of the electric vehicle is remarkably reduced.

In order to solve the reduction in the driving distance of the automobile by reducing the power consumed for heating and cooling, it is necessary to minimize the transfer of heat due to the temperature difference between the outside of the automobile and the inside of the automobile to reduce energy loss required for heating and cooling. To this end, for example, it is necessary to improve the insulation performance of a headliner used as a ceiling interior of an automobile. Most of the conventional interior materials focus on weight reduction rather than insulation performance in order to improve driving fuel efficiency. Specifically, conventionally, a headliner having a heat insulating structure in which a fiber structure heat insulating pad and an aluminum deposition film are combined has been applied as a ceiling material inside an automobile, but in most cases, the heat insulating area is formed narrowly. That is, there is a problem inevitably staying at the level of securing local insulation performance for the automobile.

### SUMMARY OF THE INVENTION

A technological object to be achieved by the present invention is to provide a headliner for an automobile having a low thermal conductivity of a predetermined level or less and securing excellent thermal insulation performance.

In addition, a technological object to be achieved by the present invention is to provide a manufacturing method of a headliner which is easy to manufacture and may reduce manufacturing cost.

The object to be solved by the present invention is not limited to the objects mentioned above, and other objects not mentioned will be clearly understood by those skilled in the art from the following description.

According to embodiments of the present invention for achieving the above objects, there is provided a headliner for an automobile comprising: a base layer; a hot melt layer laminated on the base layer; and a vacuum insulator layer laminated on the hot melt layer.

There is provided a vacuum insulator comprising: an outer covering material part defining an inner space; a core material part filled in the inner space of the outer covering material part; and an adsorbent disposed in the inner space of the outer covering material part together with the core material part, and wherein the core material part includes a multi-layer structure in which a plurality of unit sheets are laminated, and each of the unit sheets is configured to include glass fibers, the multi-layer structure may include 10 or more unit sheets, and the inner space of the outer covering material part in which the core material part and the adsorbent are disposed has a vacuum state.

A weight per unit area of the glass fibers in each of the unit sheets may be less than about 100 g/m².

The weight per unit area of the glass fibers in each of the unit sheets may be about 10 g/m² to about 70 g/m².

An average diameter of the glass fibers may be 13 µm or less.

An average diameter of the glass fibers may be 6 µm or more.

An average length of the glass fibers may be about 1 mm to 50 mm.

The unit sheet may have a thickness of 5 mm or less.

The vacuum insulator may have a thermal conductivity of 1.5 mW/ (m·K) or less.

The outer covering material part may include a multi-film structure, and the multi-film structure may include L-LDPE (linear low density polyethylene) layer or CPP (cast polypropylene) layer / Al layer or VM-EVOH (vacuum metallized ethylene vinyl)-alcohol copolymer) layer / nylon layer and VM-PET (vacuum metalized polyethylene terephthalate) layer which are sequentially stacked.

The adsorbent may include a moisture adsorbent and a gas adsorbent.

According to other embodiments of the present invention, there is provided a method for manufacturing a vacuum insulator comprising: preparing an outer covering material part defining an inner space, a core material part, and an adsorbent, respectively; disposing the core material part and the adsorbent in the inner space of the outer covering material part; and making the inner space of the outer covering material part in which the core material part and the adsorbent are disposed into a vacuum state, and wherein the preparing of the core material part includes forming a plurality of unit sheets including glass fibers; and forming a multi-layer structure by laminating the plurality of unit sheets and pressing them, and the multi-layer structure includes 10 or more unit sheets.

The forming the multi-layer structure may include performing a thermal compression process on a laminate in which the plurality of unit sheets are stacked.

The forming of the multi-layer structure may include performing a needling process on a laminate in which the plurality of unit sheets is stacked, and performing a thermal compression process on the laminate.

The needling process may be performed for a portion of a thickness of the laminate from one surface of the laminate.

A weight per unit area of the glass fibers in each of the unit sheets may be less than about 100 g/m².

The weight per unit area of the glass fibers in each of the unit sheets may be about 50 g/m² to about 70 g/m².

An average length of the glass fibers may be about 1 mm to 50 mm.

The unit sheet may have a thickness of 5 mm or less.

The vacuum insulator may have a thermal conductivity of 1.5 mW/ (m·K) or less.

According to other embodiments of the present invention, there is provided a vacuum insulator comprising: an outer covering material part defining an inner space; a core material part filled in the inner space of the outer covering material part; and an adsorbent disposed in the inner space of the outer covering material part together with the core material part, and wherein the core material part includes a multi-layer structure in which a plurality of unit sheets are stacked, each of the unit sheets is configured to include glass fibers, the glass fibers includes Na₂O, a total content of Na₂O in the glass fiber is 0.3 wt% or less, and the inner space of the outer covering material part in which the core material part and the adsorbent are disposed has a vacuum state.

The multi-layer structure may include 10 or more unit sheets.

A weight per unit area of the glass fibers in each of the unit sheets may be less than about 100 g/m².

The weight per unit area of the glass fibers in each of the unit sheets may be about 50 g/m² to about 70 g/m².

An average diameter of the glass fibers may be 13 µm or less.

An average diameter of the glass fibers may be 6 µm or more.

An average length of the glass fibers may be about 1 mm to 50 mm.

The unit sheet may have a thickness of 5 mm or less.

The vacuum insulator may have a thermal conductivity of 1.5 mW/ (m·K) or less.

The outer covering material part may include a multi-film structure, and the multi-film structure may include L-LDPE (linear low density polyethylene) layer or CPP (cast polypropylene) layer / Al layer or VM-EVOH (vacuum metallized ethylene vinyl)-alcohol copolymer) layer / nylon layer and VM-PET (vacuum metalized polyethylene terephthalate) layer which are sequentially stacked

The adsorbent may include a moisture adsorbent and a gas adsorbent.

According to embodiments of the present invention, a headliner for automobiles having improved thermal insulation performance may be implemented by using a vacuum insulator having a low thermal conductivity of a predetermined level or less and excellent thermal insulation performance. For example, according to an embodiment of the present invention, a vacuum insulator having a thermal conductivity (initial thermal conductivity) of about 1.5 mW/ (m·K) or less and correspondingly excellent thermal insulation performance may be implemented. When using such a vacuum insulator, it is possible to improve energy efficiency by reducing heat loss while reducing the thickness of the insulating layer.

In addition, according to embodiments of the present invention, a method for manufacturing a headliner for automobiles which is easy to manufacture, may reduce manufacturing cost, is easy to control the thickness, and has an excellent surface condition of a core material may be provided.

In addition, according to embodiments of the present invention, it is possible to provide an eco-friendly vacuum insulator and a manufacturing method thereof capable of minimizing environmental pollution by utilizing glass fibers harmless to the human body.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a side cross-sectional diagram illustrating a laminated structure of a headliner for an automobile according to an embodiment of the present invention.

FIG. 2 is a side cross-sectional diagram illustrating a laminated structure of a headliner base layer according to an embodiment of the present invention.

FIG. 3 is a side cross-sectional diagram illustrating a laminated structure of a vacuum insulator layer according to an embodiment of the present invention.

FIG. 4 is a detailed diagram of ‘A’ part of FIG. 3.

FIG. 5 is a side cross-sectional diagram illustrating a laminated structure of a vacuum insulator layer according to another embodiment of the present invention.

FIG. 6 is a cross-sectional diagram for explaining a configuration of a core material part which may be applied to a vacuum insulator layer according to an embodiment of the present invention.

FIG. 7 is a cross-sectional diagram for explaining a configuration of a core material part applied to a vacuum insulator in a comparative example.

FIG. 8 is an image illustrating a microstructure of glass fibers included in a core material part applied to a vacuum insulator according to an embodiment of the present invention.

FIG. 9A and FIG. 9B are cross-sectional diagrams illustrating a process of forming a core material part applied to a vacuum insulator layer according to an embodiment of the present invention.

FIG. 10A to FIG. 10D are diagrams for explaining a process for forming a core material part applied to a vacuum insulator layer according to an embodiment of the present invention.

FIG. 11 is a diagram for explaining a method for forming a core material part applied to a vacuum insulator according to another embodiment of the present invention.

FIG. 12 is a cross-sectional diagram illustrating a configuration of an outer covering material part which may be applied to a vacuum insulator layer according to an embodiment of the present invention.

FIG. 13 is a cross-sectional diagram illustrating a modified form of the vacuum insulator layer 200 according to an embodiment of the present invention.

FIG. 14 is a perspective diagram illustrating the overall shape of the vacuum insulator 200 according to an embodiment of the present invention.

FIG. 15 is a photographic image illustrating a vacuum insulator manufactured according to an embodiment of the present invention.

FIG. 16 to FIG. 20 are photographic images illustrating various structures of the vacuum insulator layer formed according to the shape of the headliner, according to embodiments of the present invention.

FIG. 21 is a process chart illustrating a manufacturing process of a headliner for automobiles to which a vacuum insulator is applied according to an embodiment of the present invention.

In the following description, the same or similar elements are labeled with the same or similar reference numbers.

### DETAILED DESCRIPTION

Hereinafter, a preferred embodiment of the present disclosure will be elucidated in detail with reference to the accompanying drawings.

The embodiments of the present disclosure are provided for more completely explaining the present disclosure to those skilled in the art, the below embodiments can be modified to various forms and the scope of the present disclosure is not limited to the below embodiments. These embodiments are rather provided for more faithfully and completely explaining the present disclosure and for completely conveying the spirit of the present disclosure to those skilled in the art.

In the drawings, in addition, the dimension or thickness of each layer is exaggerated for clarity and convenience of the description and the same reference numeral indicates the same structural element. As used in the detail description, the term “and/or” includes any one of the listed items and one or more combination thereof. In addition, the term “connect” in the detail description means the state in which A member is directly connected to B member as well as the state in which C member disposed between A member and B member so that A member is indirectly connected to B member via C member.

The terms used herein are employed for describing the specific embodiment and the present disclosure is not limited thereto. As used in the detailed description and the appended claims, the singular forms may include the plural forms as well, unless the context clearly indicates otherwise. In addition, the terms “comprises” and/or “comprising” or “includes” and/or “including” used in the detailed description specify the presence of stated features, regions, integers, steps, operations, elements, and/or components, but do not preclude the presence or addition of one or more other features, regions, integers, steps, operations, elements, components, and/or groups thereof.

Although the terms of “first”, “second”, etc. are used herein to describe various members, parts, regions, layers and/or sections, it is obvious that these members, parts, regions, layers and/or sections should not be limited by the above terms. These terms are employed only for distinguishing one member, part, region, layer or section from another region, layer or section. Thus, the first member, the first part, the first region, the first layer or the first section described below may refer to the second member, the second part, the second region, the second layer or section without departing from the teachings of the present disclosure.

Furthermore, the terms related to a space such as “beneath”, “below”, “lower”, “above” and “upper” may be used to easily understand one element or a characteristic or another element or a characteristic illustrated in the drawings. The above terms related to the space are employed for easy understanding of the present disclosure depending on various process states or usage states of the present disclosure, and are not intended to limit the present disclosure.

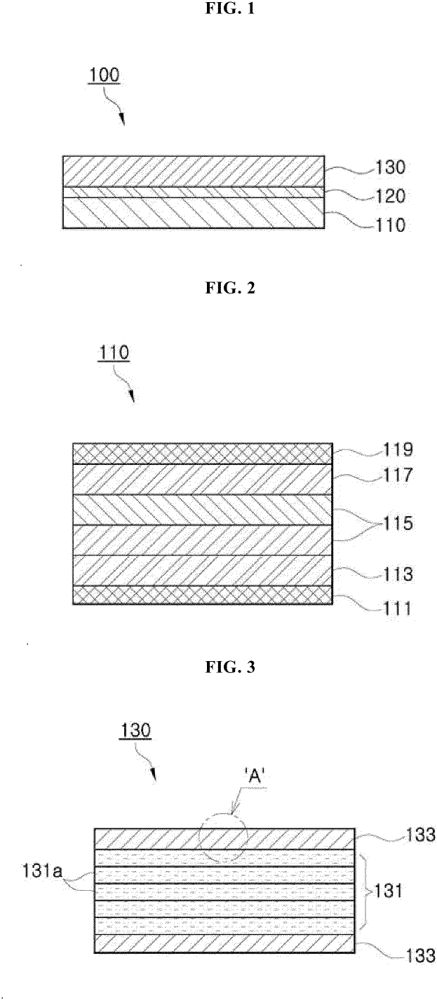

FIG. 1 is a side cross-sectional diagram illustrating a laminated structure of a headliner 100 for an automobile according to an embodiment of the present invention.

Referring to FIG. 1, the headliner 100 for an automobile according to an embodiment of the present invention includes a base layer 110, a hot melt layer 120 laminated on the base layer 110, and a vacuum insulator layer 130 laminated on the hot melt layer 120. First, the base layer 110 is a support of the headliner 100 and may be composed of a single layer or a plurality of layers. The vacuum insulator layer 130 is laminated on the base layer 110 via the hot melt layer 120, and may be integrally formed through a laminating process.

FIG. 2 is a side cross-sectional diagram illustrating a laminated structure of a headliner base layer according to an embodiment of the present invention.

Referring to FIG. 2, the base layer 110 may include a first nonwoven fabric layer 111, a first reinforcing layer 113 laminated on the first nonwoven fabric layer 111, and a polyurethane layer 115 laminated on the first reinforcing layer 113, a second reinforcing layer 117 laminated on the polyurethane layer 115, and a second nonwoven fabric layer 119 laminated on the second reinforcing layer 117.

In this case, the first reinforcing layer 113 and the second reinforcing layer 117 may be made of various synthetic resin materials, as non-limiting examples, well-known thermosetting resins for securing appropriate strength. In addition, the polyurethane layer 115 may be a multi-layer body in which a plurality of layers of two or more layers are stacked. The polyurethane layer 115 may have a foam structure for securing heat insulation performance. In other embodiments, the polyurethane layer 115 may be omitted to reduce thickness and light weight. The base layer 110 of this laminated structure may be press-molded into a predetermined shape through a forming process using a hot press.

Referring back to FIG. 1, the vacuum insulator layer 130 is laminated on top of the base layer 110 via the hot melt layer 120, and may be integrally molded through a laminating process.

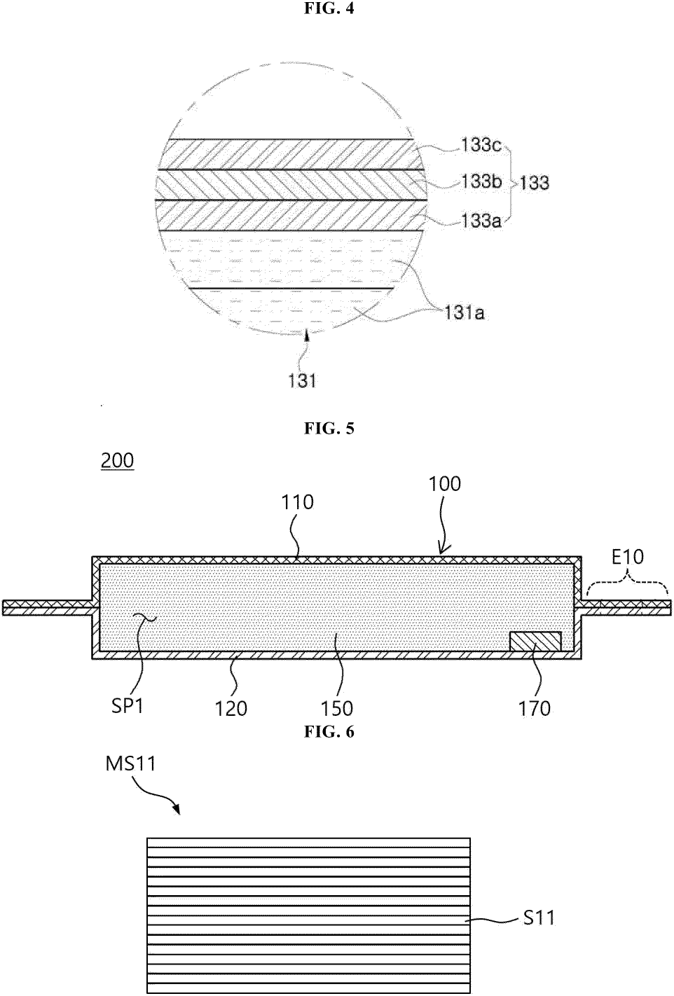

FIG. 3 is a side cross-sectional diagram illustrating a laminated structure of a vacuum insulator layer 130 according to an embodiment of the present invention, and FIG. 4 is a detailed diagram of part ‘A’ of FIG. 3.

Referring to FIG. 3, the vacuum insulator layer 130 may include a core material part 131 formed by laminating thin glass fiber sheets 131a in which glass fibers are horizontally arranged in one or multiple layers, and an outer covering material part 133 for vacuum packaging the core material part 131. The inner surfaces of the edge portions of an upper outer covering material part 133 and a lower outer covering material part 133 are adhered to each other to maintain airtightness.

In one embodiment, the core material part 131 is formed of glass fibers to a predetermined length, and it is molded into the glass fiber sheet 131a after horizontally arranging the glass fibers.

In this case, the glass fibers may have an average diameter of 6 µm to 13 µm. That is, when the diameter of the glass fibers is less than 6 µm, the porosity of the core material part 131 formed by the wet manufacturing method is too small, resulting in deterioration in heat insulation performance. On the other hand, when the average diameter of the glass fibers exceeds 13 µm, there is a concern that long-term durability may be deteriorated because the pore size increases.

In addition, the length of the glass fiber may be formed into a long fiber of at least 1 mm or more, preferably 1 mm to 50 mm. That is, when the glass fibers are formed to a length of 1 mm to 50 mm, the effect that the thermal conductivity is improved increases as the horizontal arrangement of the glass fibers is optimized, and thus the insulation performance of the vacuum insulator may be improved.

When the glass fibers are formed to a length of 1 mm or less, as the glass fibers constituting the core material part are randomly arranged in the vertical direction rather than horizontally, the initial insulation performance deteriorates. Conversely, when the glass fibers are formed to a length of 50 mm or more, difficulties arise in the molding process due to the brittle nature of the glass fibers.

In one embodiment, the glass fibers may be, for example, flame-processed glass fibers, centrifugal-processed glass fibers, and/or continuous filament long fibers to improve long-term durability. If necessary, the core material part 131 may further optionally include one or more of fumed silica powder, silica powder, perlite powder, aerogel powder, and polyurethane foam together with glass fibers. The glass fiber may be manufactured into the core material part 131 by any one of a wet manufacturing method (mesh belt), a thermo-compression bonding method, an inorganic binder bonding method, and a needling processing method. In this case, at least one glass fiber sheet 131 or more may be laminated to constitute the core material part 131. Preferably, the plurality of glass fiber sheets 131a may be laminated by needling or thermal compression.

The outer covering material part 133 vacuum-packs the core material part 131 as an air barrier layer. In one embodiment, as shown in FIG. 4, the outer covering material part 133 may have a laminated structure in which an adhesive layer 133a, a metal barrier layer 133b, and a surface protection layer 133c are laminated from the inside to the outside of the vacuum insulator layer 130.

Specifically, the adhesive layer 133a is a layer which is thermally fused to each other, and maintains a vacuum state inside the vacuum insulator layer 130 by sealing. The adhesive layer 133a may include at least one or more selected from high-density polyethylene (HDPE), low-density polyethylene (LDPE), linear low-density polyethylene (LLDPE), unstretched polypropylene (CPP), stretched polypropylene (OPP), polyvinylidene chloride (PVDC), or polyvinyl chloride (PVC), ethylene-vinyl acetate copolymer (EVA), and ethylene-vinyl alcohol copolymer (EVOH). The adhesive layer 133a is preferably formed to a thickness of 1 µm to 100 µm so as to provide sufficient sealing properties.

The metal barrier layer 133b for blocking gas and protecting the core material part 131 may be stacked on top of the adhesive layer 133a. Here, preferably, such a metal barrier layer 133b may be made of an aluminum foil having a thickness of 6 µm to 20 µm and a polyethylene terephthalate (PET) material.

In addition, the surface protection layer 133c may be stacked on top of the metal barrier layer 133b. The surface protection layer 133c may prevent cracks from occurring when the metal barrier layer 133b made of a metal material is folded. As a non-limiting example, the surface protection layer 133c may have a structure in which polyethylene terephthalate (PET) having a thickness of 10 µm to 30 µm and nylon having a thickness of 10 µm to 40 µm are stacked.

The aforementioned vacuum insulator layer 130 may be formed as an ultra-thin film having a thickness of 3 mm or less. In this case, even though the vacuum insulator layer 130 has an ultra-thin structure, as the glass fibers constituting the core material part 131 are arranged horizontally, that is, in a direction parallel to the main surface of the car ceiling, the thermal conductivity in the vertical direction is reduced and has selective thermal conductivity only in the horizontal direction. Therefore, for example, while maximally blocking the heat transfer path from the inside to the outside, that is, in the vertical direction, of an automobile requiring improvement in fuel efficiency, such as an electric vehicle or a hybrid vehicle, at the same time, convection is suppressed by the vacuum inside the vacuum insulator layer 130, so that the insulation effect may be maximized.

FIG. 5 is a side cross-sectional diagram illustrating a laminated structure of a vacuum insulator layer according to another embodiment of the present invention.

Referring to FIG. 5, a vacuum insulator layer 200 according to an embodiment of the present invention may include an outer covering material part 100 defining an inner space SP1 (i.e., an accommodation space), and a core material part 150 filled in the inner space SP1 of the outer covering material part 100 and an adsorbent 170 disposed in the inner space SP1 of the outer covering material part 100 together with the core material part 150

The outer covering material part 100 may include a first outer covering material part 110 and a second outer covering material part 120 facing the first outer covering material part 110. Edges of the first outer covering material part 110 and the second outer covering material part 120 may be bonded, and the internal space SP1 may be defined between the first outer covering material part 110 and the second outer covering material part 120. In FIG. 1, a portion indicated by reference number E10 represents an edge portion where the first outer covering material part 110 and the second outer covering material part 120 are bonded, that is, ‘a wing portion’. The wing portion E10 may be referred to as a kind of extension or expansion portion. A specific configuration that the outer covering material part 100 may have will be described in more detail later with reference to FIG. 9.

The core material part 150 may include an inorganic material having a high porosity, for example, a porosity of 50% or more or 70% or more (porosity measured by mercury porosimetry) based on the total volume of the core material part 150. The inorganic material may include glass fibers and may have a porous structure in which pores are defined between adjacent glass fibers. A specific configuration which the core material part 150 may have will be described in more detail with reference to FIG. 6 below.

The adsorbent 170 may be a member for adsorbing moisture and/or gas. Although only one adsorbent 170 is shown in FIG. 1 for convenience, in practice, the adsorbent 170 may include a moisture adsorbent and a gas adsorbent provided separately therefrom. One or more moisture adsorbents and one or more gas absorbents may be disposed in the inner space SP1 of the outer covering material part 100.

The moisture adsorbent may include, for example, calcium oxide, and may further include a metal oxide together with the calcium oxide. The moisture adsorbent may have a thin pack or pouch form. However, the material and the shape of the moisture adsorbent are not limited to the above and may be variously changed.

The gas absorbent may serve to adsorb gases such as hydrogen, oxygen, nitrogen, and carbon dioxide (CO₂). The gas absorbent may include, for example, a metal oxide such as silver (Ag) oxide or copper (Cu) oxide, and may further include a small amount of calcium oxide and a metal such as cobalt (Co), barium (Ba), lithium (Li) or zeolite together with the metal oxide. The gas absorbent may have a coin shape, a bar shape, or a nonwoven fabric shape. However, the material and the shape of the gas absorbent are not limited to the above and may be variously changed.

The gas absorbent may serve to adsorb gases such as hydrogen, oxygen, nitrogen, and carbon dioxide (CO₂). The gas absorbent may include, for example, a metal oxide such as silver (Ag) oxide or copper (Cu) oxide, and may further include a small amount of calcium oxide and a metal such as cobalt (Co), barium (Ba), lithium (Li) or zeolite together with the metal oxide. The gas absorbent may have a coin shape, a bar shape, or a nonwoven fabric shape. However, the material and the shape of the gas absorbent are not limited to the above and may be variously changed.

Referring to FIG. 6, a core material part applied to a vacuum insulator according to an embodiment of the present invention may include a multi-layer structure MS11 in which a plurality of unit glass fiber sheets (S11; hereinafter referred to as unit sheets) are stacked. The multi-layer structure MS11 may be a kind of ‘glass fiber board’. Here, each of the unit sheets S11 may be configured to include glass fibers as described above. In each unit sheet S11, a basis weight or areal density based on a single layer of glass fiber may be less than about 160 g/m², more preferably less than 100 g/m². The areal density of the glass fibers in each unit sheet S11 may mean the total weight per unit area of the glass fibers when it is assumed that the unit sheet S11 is composed of a single layer of glass fibers. A low areal density of the glass fibers in each unit sheet S11 may mean that the thickness of the unit sheet S11 is thin or that the diameter of the glass fibers used in the unit sheet S11 is small.

In one embodiment, the areal density of the glass fibers in each unit sheet S11 may be, for example, about 10 g/m² to 70 g/m². In addition, the average diameter of the glass fibers may be about 13 µm or less. For example, the average diameter of the glass fibers may be about 6 µm or more and about 13 µm or less. In the vacuum insulator, each unit sheet S11 may have a thickness of about 5 mm or less. In addition, the multi-layer structure MS11 may include a large number of unit sheets S11, for example, about 10 or more unit sheets S11, preferably about 15 or more unit sheets S11. The number of unit sheets S11 constituting the multi-layer structure MS11 may be about 10 or more and about 100 or less. As the number of stacked unit sheets S11 increases while maintaining the thickness of the entire core material part constant, the thickness of each unit sheet S11 decreases.

In one embodiment, the horizontal arrangement characteristics of the glass fibers may be greatly improved throughout the multi-layered structure MS11 in which 15 or more unit sheets are stacked. Specifically, the glass fibers in each unit sheet S11 have a randomly arranged nonwoven fabric characteristic, but in each unit sheet S11 having an areal density of 50 g/m² ~ 70 g/m², the horizontally arranged component of the glass fibers may be larger than the vertically arranged component, and thus, the arrangement density of the glass fibers in the horizontal direction is maximized in the micro-thickness unit sheet S11. As a result, the vertical connection of the glass fibers between the plurality of unit sheets S11 may be minimized. Since a large number of unit sheets S11 are stacked and the glass fibers are arranged in a substantially horizontal direction within each unit sheet S11, the connection between the glass fibers between two adjacent unit sheets S11 may be a point contact, and the continuity of the connection in the vertical direction may be minimized or effectively suppressed. Accordingly, conduction of heat through the glass fibers may be mainly performed in a horizontal direction along the plane of the unit sheet S11, and conduction of heat between the unit sheets S11 in a vertical direction may be effectively blocked. As a result, as the vacuum insulator according to the embodiment of the present invention not only blocks thermal shear due to radiation by vacuum, but also thermal shear between unit sheets S11, the heat conduction between the two main surfaces facing each other of the vacuum insulator is suppressed and thus, very excellent thermal insulation performance may be obtained. For example, the vacuum insulator according to an embodiment of the present invention may have a very low thermal conductivity (initial thermal conductivity) of about 1.5 mW/(m·K) or less. However, the limiting thermal conductivity of the vacuum insulator may be greater than about 0.5 mW/ (m ·K), for example.

In one embodiment, the horizontal arrangement characteristics of the glass fibers may be greatly improved throughout the multi-layered structure MS11 in which 15 or more unit sheets are stacked. Specifically, the glass fibers in each unit sheet S11 have a randomly arranged nonwoven fabric characteristic, but in each unit sheet S11 having an areal density of 50 g/m² ~ 70 g/m², the horizontally arranged component of the glass fibers may be larger than the vertically arranged component, and thus, the arrangement density of the glass fibers in the horizontal direction is maximized in the micro-thickness unit sheet S11. As a result, the vertical connection of the glass fibers between the plurality of unit sheets S11 may be minimized. Since a large number of unit sheets S11 are stacked and the glass fibers are arranged in a substantially horizontal direction within each unit sheet S11, the connection between the glass fibers between two adjacent unit sheets S11 may be a point contact, and the continuity of the connection in the vertical direction may be minimized or effectively suppressed. Accordingly, conduction of heat through the glass fibers may be mainly performed in a horizontal direction along the plane of the unit sheet S11, and conduction of heat between the unit sheets S11 in a vertical direction may be effectively blocked. As a result, as the vacuum insulator according to the embodiment of the present invention not only blocks thermal shear due to radiation by vacuum, but also thermal shear between unit sheets S11, the heat conduction between the two main surfaces facing each other of the vacuum insulator is suppressed and thus, very excellent thermal insulation performance may be obtained. For example, the vacuum insulator according to an embodiment of the present invention may have a very low thermal conductivity (initial thermal conductivity) of about 1.5 mW/(m·K) or less. However, the limiting thermal conductivity of the vacuum insulator may be greater than about 0.5 mW/ (m ·K), for example.

The average length of the glass fibers may be about 1 mm to about 50 mm. The glass fiber used in the embodiment of the present invention may be a type of long fiber. The glass fiber may be ‘chopped glass fiber’. In this case, the horizontal arrangement characteristics of the glass fibers in each unit sheet S11 may be further improved. Therefore, it may be more advantageous to lower the thermal conductivity (initial thermal conductivity) of the vacuum insulator according to the embodiment to about 1.5 mW/ (m·K) or less.

In the vacuum insulator according to an embodiment of the present invention, the thickness of the multi-layer structure MS11 compressed by vacuum may be about 0.5 cm to about 5 cm, for example, about 0.8 cm to about 1 cm. However, this thickness range is only exemplary, and the appropriate thickness of the multi-layer structure MS11 may be variously changed according to the application of the vacuum insulator.

Additionally, according to an embodiment of the present invention, the unit sheet S11 may be composed of only glass fibers, or may be composed of glass fibers as a main component, and in some cases, it may have a structure including porous powder or organic materials such as silica powder and organic fibers (PP, PET fibers) together with glass fibers.

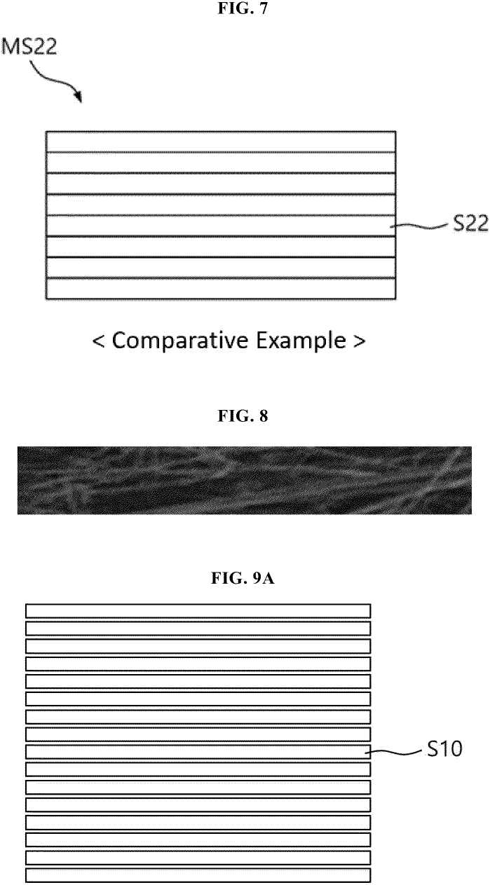

FIG. 7 is a cross-sectional diagram for explaining a configuration of a core material part applied to a vacuum insulator in a comparative example.

Referring to FIG. 7, the core material part applied to the vacuum insulator according to the comparative example may include a multi-layer structure MS22 in which a plurality of unit sheets S22 are stacked. Here, each of the unit sheets S22 may be configured to include glass fibers. The weight per unit area of the glass fibers in each unit sheet S22, that is, the areal density, may be about 100 g/m² ~ 145 g/m². In addition, the average diameter of the glass fibers may be about 8.5 µm to 12 µm. In addition, as compared to the multi-layer structure MS11 according to the embodiment described in FIG. 6, the number of unit sheets S22 constituting the multi-layer structure MS22 may be half or close to half, based on the case where the total thickness of the multi-layer structure MS22 of the comparative example is equal to the total thickness of the multi-layer structure MS11.

As in the comparative example of FIG. 7, when the weight per unit area of the glass fibers in each unit sheet S22 is about 100 g/m² ~ 145 g/m², and the average diameter of the glass fibers is about 12 µm ~ 13 µm, and the number of stacked unit sheets S22 is relatively small, the thermal conductivity (initial thermal conductivity) of the vacuum insulator according to the comparative example including the multi-layer structure MS22 to which the unit sheets S22 are applied is about 1.75 mW/(m·K). This may be higher than the thermal conductivity [about 1.5 mW/(m·K) or less] of the vacuum insulator according to the embodiment to which the multi-layer structure MS11 of FIG. 2 is applied. Therefore, the vacuum insulator according to the embodiment to which the multi-layer structure MS11 shown in FIG. 6 is applied may exhibit significantly improved insulation performance as compared to the vacuum insulator according to the comparative example to which the multi-layer structure MS22 shown in FIG. 7 is applied.

FIG. 8 is an image illustrating a microstructure of glass fibers included in a core material part applied to a vacuum insulator according to an embodiment of the present invention.

Referring to FIG. 8, the glass fibers included in the core material part applied to the vacuum insulator according to an embodiment of the present invention are arranged in a horizontal direction substantially parallel to the main surface of the multi-layer structure within the unit sheet to form a network structure, even throughout the multi-layer structure in which the unit sheets are laminated. The glass fiber may have a fiber structure similar to a kind of nonwoven fabric. However, the microstructure of the glass fiber shown in FIG. 8 is only exemplary and may be variously changed.

A manufacturing method of a vacuum insulator according to an embodiment of the present invention may include preparing an outer covering material part defining an inner space, a core material part, and an adsorbent, respectively, disposing the core material part and the adsorbent in the inner space of the outer covering material part, and making the inner space of the outer covering material part in which the core material part and the adsorbent are disposed into a vacuum state. In connection with the outer covering material part, a first outer covering material part and a second outer covering material part having a corresponding shape may be disposed to face each other, and the edges thereof may be bonded by thermal fusion method to form the above-described internal space there between. Some of the edge portions of the first outer covering material part and the second outer covering material part may be left unbonded and used as an opening (entrance) through which the interior space may be accessed from the outside. The core material part and the adsorbent may be disposed in the inner space defined by the outer covering material part through the opening. Thereafter, air in the inner space may be removed through the opening by an adsorption method to make a vacuum state, and the opening may be sealed by a thermal fusion method. Here, the core material part and the adsorbent may correspond to the core material part 150 and the adsorbent 170 described with reference to the previous drawings. However, the specific method of manufacturing the vacuum insulator described above is exemplary and known techniques in the art may be referred to.

In the manufacturing method of the vacuum insulator layer according to the embodiment, the step for preparing the core material part may include forming a plurality of unit sheets including glass fibers and laminating the plurality of unit sheets and hot pressing them to form a multi-layer structure, and a weight per unit area of the glass fibers in each of the unit sheets may be less than about 100 g/m².

FIG. 9A and FIG. 9B are cross-sectional diagrams illustrating a process of forming a core material part applied to a vacuum insulator layer according to an embodiment of the present invention.

Referring to FIG. 9A, preparing a core material part may include forming a plurality of unit sheets S10 including glass fibers.

Referring to FIG. 9B, preparing the core material part may include forming a multi-layer structure MS10 by stacking the plurality of unit sheets S10 and compressing them.

The multi-layer structure MS10 as shown in FIG. 9B may be put into the inner space of the outer covering material part together with the adsorbent, and the inner space may be vacuumed. As the inner space is made into a vacuum state, the multi-layer structure MS10 may be further compressed in its thickness direction. The ‘multi-layer structure’ of the core material part disposed inside the vacuum insulator manufactured in this way may correspond to the multi-layer structure MS11 described with reference to FIG. 6.

The weight per unit area of the glass fibers in each unit sheet S10 may be less than about 100 g/m², for example, about 50 g/m² ~ 70 g/m². The average diameter of the glass fibers may be about 13 µm or less, for example, about 6 µm to about 13 µm. The average length of the glass fibers may be about 1 mm to about 50 mm. The multi-layer structure MS10 may include 15 unit sheets S10 or more. After manufacturing the vacuum insulator, the thickness of the unit sheet (i.e., corresponding to S11 in FIG. 6) in a state included in the vacuum insulator may be about 5 mm or less. These conditions and technological effects thereof may be the same as those described with reference to FIG. 6. As a result, according to an embodiment of the present invention, a vacuum insulator with excellent performance having a very low thermal conductivity (initial thermal conductivity) of about 1.5 mW/ (m·K) or less may be manufactured. When using such a vacuum insulator, it is possible to remarkably improve energy efficiency by reducing heat loss while reducing the thickness of the insulating layer.

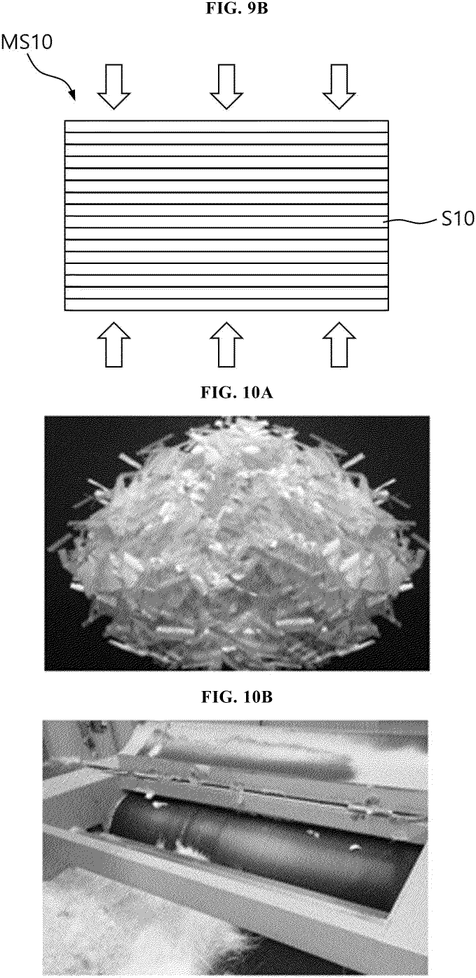

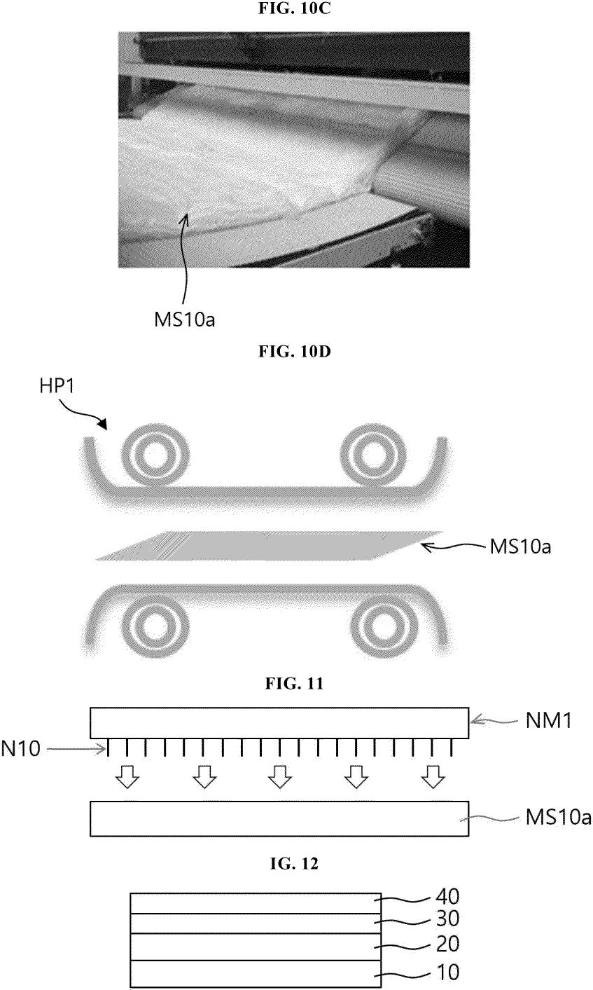

FIG. 10A to FIG. 10D are diagrams for explaining a process for forming a core material part applied to a vacuum insulator layer according to an embodiment of the present invention.

Referring to FIG. 10A, it shows glass fibers which may be used for manufacturing a core material part. The glass fibers may have an average diameter of about 13 µm or less or about 8.5 µm or less. In addition, the average length of the glass fibers may be about 1 mm to about 50 mm.

FIG. 10B shows an equipment (thinning equipment) for thinning the glass fibers. A unit sheet may be formed via the steps for dispersing the glass fibers on a surface of a roller, and randomly arranging the glass fibers mainly in a horizontal direction by using this equipment. The unit sheet may have a predetermined thickness. The unit area weight of the glass fibers in each of the unit sheets may be less than about 100 g/m², for example, about 50 g/m² ~ 70 g/m². The unit sheet may be manufactured, for example, in a manner similar to that of nonwoven fabric. In this way, a plurality of unit sheets may be manufactured.

Referring to FIG. 10C, one laminate may be formed by stacking a plurality of unit sheets described above. This laminate is designated by the reference number MS10a.

Referring to FIG. 10D, a thermal compression process (thermal compression bonding process) may be performed on the laminate MS10a in which the plurality of unit sheets is stacked to form a multi-layer structure in which the plurality of unit sheets is compressed (bonded). At this time, a predetermined thermo-compression equipment HP1 may be used. The thermo-compression equipment HP1 may include a hot press. In the thermo-compression process, the thermo-compression temperature may be, for example, about 600° C. or higher. In the thermo-compression process, the laminate MS10a may be heated to, for example, about 500° C. to 750° C. In this way, a multi-layer structure MS10 as shown in FIG. 9B may be formed.

In some cases, before a temporary bonding step for performing a needling process on the laminate MS10a in which a plurality of unit sheets is stacked may be further included before performing the thermo-compression process. In other words, the step for forming the multi-layer structure may include a step for performing a needling process on the laminate MS10a in which a plurality of unit sheets is stacked, and a step for performing a thermal compression process on the laminate MS10a. The above needling process is illustrated in FIG. 11.

Referring to FIG. 11, after disposing a needle mat NM1 including a plurality of needles N10 above the laminate MS10a in which the plurality of unit sheets is stacked, a needling process for penetrating the laminate MS10a with the plurality of needles N10 may be performed by moving the needle mat NM1 up and down. An end of the needle N10 may have a structure bent in a predetermined shape. Accordingly, temporary joining is induced by bridging between adjacent unit sheets.

In one embodiment, the needling process may be performed only for a partial thickness of the laminate MS10a from one surface (an upper surface in the drawing) of the laminate MS10a, or may be performed for a limited amount of time and frequency at a level where the horizontal orientation component of the glass fibers is maintained greater than the vertical orientation component.

The needling process for a partial thickness means that the needle is not passed through the laminate MS10a in the thickness direction, and the process is performed only for a partial thickness of one surface portion (upper surface portion in the drawing) of the laminate MS10a. A process for performing this needling process for some thickness minimizes the orientation of the glass fibers in the thickness direction of the laminate which induces bridging, thereby reducing increase of the thermal conductivity between the principal surfaces facing each other which are caused due to the glass fibers having mainly a vertical component for bridging. Through this needling process, a plurality of unit sheets may form a state in which a plurality of unit sheets is temporarily bonded to some extent while the glass fibers are woven in a vertical direction in a portion of the laminate MS10a. After performing such a needling process, a multi-layer structure may be formed by performing a thermo-compression bonding process as described in FIG. 10D. However, the needling process described in FIG. 11 is exemplary and may be optional.

According to an embodiment of the present invention, it is possible to easily form a core material part having excellent horizontal arrangement characteristics of glass fibers and excellent surface conditions. In addition, it is very easy to adjust the thickness of the core material part according to various headliner standards by adjusting the number of stacked unit sheets. In addition, the manufacturing method of the vacuum insulator according to the embodiment has excellent workability and may be advantageous in reducing manufacturing cost.

FIG. 12 is a cross-sectional diagram illustrating a configuration of an outer covering material part which may be applied to a vacuum insulator layer according to an embodiment of the present invention.

Referring to FIG. 12, an outer covering material part applicable to the vacuum insulator layer according to an embodiment of the present invention may include a multi-film structure. The multi-film structure may include, for example, L-LDPE (linear low density polyethylene) layer 10 or CPP (cast polypropylene) layer 10 / Al layer 20 or VM-EVOH (vacuum metallized ethylene vinyl-alcohol copolymer) layer 20 / a nylon layer 30 and a VM-PET (vacuum metallized polyethylene terephthalate) layer 40 which are sequentially stacked from an inside to an outside. The Al layer 20 may be a kind of Al foil. In the multi-film structure, L-LDPE serves as an adhesive layer and performs a bonding process by thermal fusion or ultrasonic fusion.

This multi-film structure may be applied to both the first outer covering material part 110 and the second outer covering material part 120 of FIG. 5. The outer covering material part having such a structure may serve to protect the core material part and the adsorbent while effectively blocking the permeation of gas and moisture. However, the configuration of the outer covering material part described with reference to FIG. 12 is exemplary, and may be variously changed depending on the case.

FIG. 13 is a cross-sectional diagram illustrating a modified form of the vacuum insulator layer 200 according to an embodiment of the present invention. FIG. 13 shows a form in which the wing portion E10 is folded and attached to a body portion of the vacuum insulator 200 in the structure of FIG. 5. The wing portion E10 may be attached to face the lower surface or the upper surface of the body. When attaching the wing portion E10, a predetermined adhesive member such as an adhesive tape may be used. The vacuum insulator 200 may have a shape such as a quadrangular panel or a substantially hexahedron, or a polyhedron having a chamfered shape with a portion of a corner cut off by folding and attaching the wings E10.

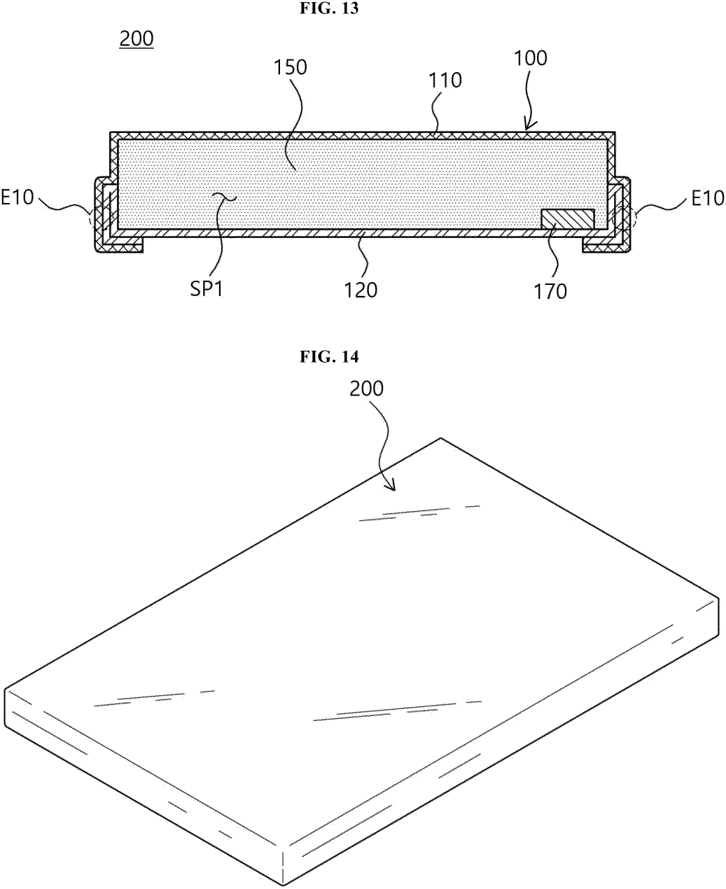

FIG. 14 is a perspective diagram illustrating the overall shape of the vacuum insulator 200 according to an embodiment of the present invention. As shown in FIG. 14, the vacuum insulator 200 according to an embodiment of the present invention may have a rectangular panel or a substantially hexahedral shape. The structure of the vacuum insulator 200 of FIG. 14 may correspond to the case that the wing portion E10 is folded and attached to the body portion as shown in FIG. 13.

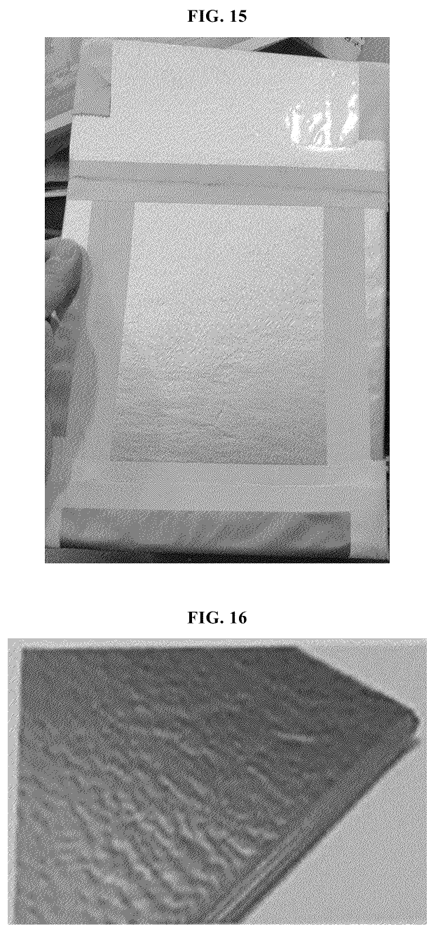

FIG. 15 is a photographic image illustrating a vacuum insulator manufactured according to an embodiment of the present invention. The vacuum insulator of FIG. 15 may have a structure corresponding to the vacuum insulator 200 of FIG. 14.

However, the structure of the vacuum insulator according to the embodiment of the present invention is not limited to the flat plate structure and may be variously changed.

FIG. 16 to FIG. 20 are photographic images illustrating various structures of the vacuum insulator layer formed according to the shape of the headliner, according to embodiments of the present invention.

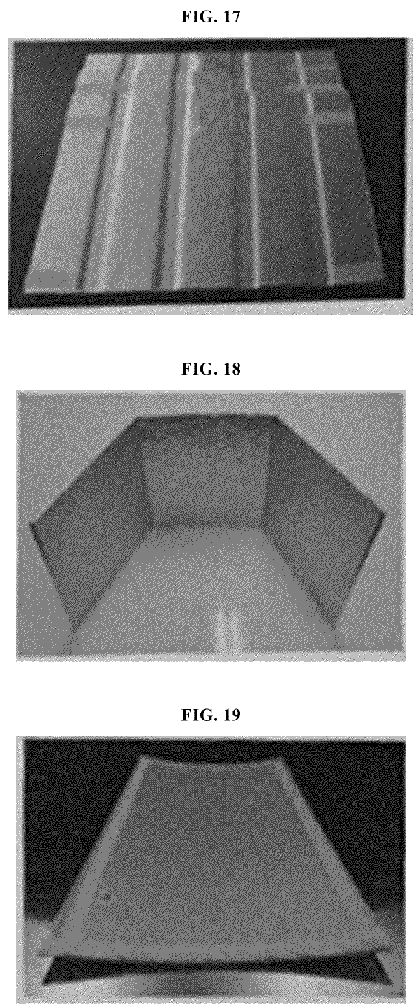

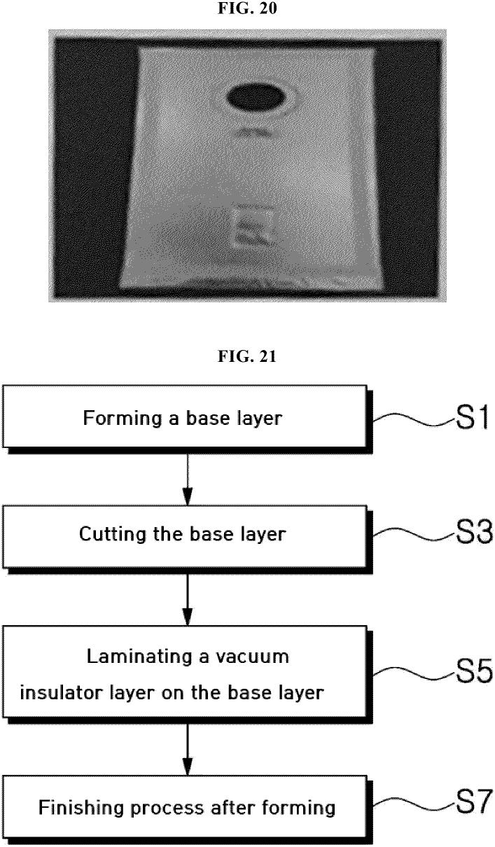

FIG. 16 shows a vacuum insulator layer of a flat structure, FIG. 17 shows a vacuum insulator layer of a dent structure with a recessed area, and FIG. 18 shows a vacuum insulator layer of a bending structure. FIG. 19 shows a vacuum insulator layer having a curved structure (i.e., bended structure), and FIG. 20 shows a vacuum insulator layer having a structure in which holes are formed. In addition, the vacuum insulator layer may have various modified structures such as a cutting type, a slim type, a cylinder type, and a round type.

Hereinafter, a manufacturing method of a headliner 100 for an automobile to which the above-described vacuum insulator layer is applied will be described.

First, the base layer 110 made of a plurality of layer (laminated structure) may be formed into a predetermined shape through a hot press process (S1). Unnecessary parts protruding from the edge of the formed base layer 110 are cut (S3). Then, the vacuum insulator layer 130 may be laminated on top of the base layer 110 via the hot melt layer 120 (S5). Then, after forming the base layer 110 on which the vacuum insulator layer 130 is laminated through a hot press process, other finishing processes are performed (S7).

After going through the above process, the headliner 100 for an automobile to which the vacuum insulator according to the present invention as shown in FIG. 1 is applied may be manufactured.

### Insulation Performance Test and Evaluation

The thermal insulation performance of the vacuum insulator was evaluated under the conditions shown in the table below.

First of all, the average diameter of the glass fibers constituting the core material part of the vacuum insulator and the arrangement method of the glass fibers are different from each other (Table 1). After manufacturing the glass fiber boards of each of two cases in Table 1, they are formed by laminating so that they may have different overall thicknesses.

Then, as a result of checking the thermal conductivity at this time while applying heat for a predetermined time in an environment of the same temperature as each of the vacuum insulators, the following results were obtained.

| | Comparative example | Embodiment |
|---|---|---|
| areal density (g/m²) | 100 ~ 145 | 50 ~ 100 |
| average diameter of glass fiber (µm) | 12 ~ 13 | 6 ~ 13 |
| average length of glass fiber (mm) | - | 1 ~ 50 |
| arrangement of glass fiber | Vertical and horizontal random arrangement | Horizontal arrangement |
| thermal conductivity (mW/mK) | 1.75 | 1.5 |

As a result of the measurement, in the case of the vacuum insulator according to the comparative example in which the glass fibers were randomly arranged vertically and horizontally, the thermal conductivity was 1.7 5 mW/mK, but in the case of the vacuum insulator manufactured by the method according to the present invention, the thermal conductivity was remarkably reduced and was measured as 1.5 mW /mK. That is, it may be confirmed that the vacuum insulator according to the present invention secures thermal insulation performance improved by at least 14% or more as compared to the vacuum insulator according to the comparative example.

As a result of testing the change in room temperature during heating of the automobile to which the headliner equipped with the vacuum insulator according to the present invention is applied and the automobile to which the vacuum insulator is not applied, the case where the vacuum insulator is applied to the headliner increased the room temperature at a faster rate than the case where the vacuum insulator is not applied (difference of at least 0.7° C. in 5 minutes to 7 minutes).

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A headliner for an automobile comprising:
a base layer;
a hot melt layer laminated on the base layer; and
a vacuum insulator layer laminated on the hot melt layer.

2. The headliner for an automobile of claim 1, wherein the base layer includes a first nonwoven fabric layer,
a first reinforcing layer laminated on the first nonwoven fabric layer,
a polyurethane layer laminated on the first reinforcing layer,
a second reinforcing layer laminated on the polyurethane layer, and
a second nonwoven fabric layer laminated on the second reinforcing layer.

3. The headliner for an automobile of claim 2, wherein the polyurethane layer is a multi-layer in which a plurality of polyurethane layers is stacked.

4. The headliner for an automobile of claim 1, wherein the vacuum insulator layer includes a core material part formed by laminating a plurality of thin glass fiber sheets in which glass fibers are horizontally arranged; and an outer covering material part for vacuum packaging the core material part.

5. The headliner for an automobile of claim 4, wherein a length of the glass fiber is in a range of 1000 µm to 1500 µm.

6. The headliner for an automobile of claim 4, wherein a diameter of the glass fiber is in a range of 1 µm to 6 µm.

7. The headliner for an automobile of claim 4, wherein a weight per unit area of the glass fibers in each of the glass fiber sheets is less than 100 g/m².

8. The headliner for an automobile of claim 7, wherein the weight per unit area of the glass fibers in each of the glass fiber sheets is 10 g/m² to 70 g/m².

9. The headliner for an automobile of claim 4, wherein the glass fiber includes any one of a flame-processed glass fiber, a centrifugal-processed glass fiber, and a continuous filament long fiber.

10. The headliner for an automobile of claim 9, wherein the vacuum insulator layer further comprises at least one of fumed silica powder, silica powder, perlite powder, and aerogel powder in the glass fiber.

11. The headliner for an automobile of claim 1, wherein the glass fiber is formed by any one of a wet manufacturing method (mesh belt), a thermo-compression method, an inorganic binder adhesion method, and a needling processing method.

12. A manufacturing method of a headliner for an automobile, comprising:
forming a base layer into a given shape through a hot press process;
cutting an edge of the formed base layer;
laminating a vacuum insulator layer on the base layer via a hot melt layer; and
finishing after forming the base layer on which the vacuum insulator layer is laminated through a hot press process.
